(19) United States
(12) Patent Application Publication
(10) Pub. No.: US 2010/0067037 A1
(43) Pub. Date: Mar. 18, 2010

(54) INFORMATION PROCESSING APPARATUS, METHOD FOR CONTROLLING THE SAME, AND STORAGE MEDIUM

(75) Inventor: Yasuhiro Takiyama, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/557,710

(22) Filed: Sep. 11, 2009

(30) Foreign Application Priority Data
Sep. 12, 2008 (JP) 2008-234442

(51) Int. Cl. G06K 15/02

(52) U.S. Cl. 358/1.14

(57) ABSTRACT

A method for controlling an information processing apparatus capable of receiving access from an external apparatuses, the method including: determining whether access from the external apparatus is permitted based on biometric information; instructing a printing unit to print a permit including the biometric information; receiving the biometric information included in the printed permit from the external apparatus; and permitting access from the external apparatus if it is determined that access from the external apparatus is permitted based on the received biometric information in a case where an access request is received from the external apparatus.

### BACKGROUND OF THE INVENTION

1. Field of the Invention

The present invention relates to an information processing apparatus, a method for controlling the same, and a storage medium.

1. Description of the Related Art

A conventional information processing apparatus shares data stored in a storage device with external information processing apparatuses via a network as discussed in Japanese Patent Application Laid-Open No. 2005-204031. When such an information processing apparatus is accessed from an external information processing apparatus, the information processing apparatus may request the external apparatus to transmit a password thereto to improve security.

After requesting the external apparatus to transmit a password, the information processing apparatus receives a password input from an operation panel of the external apparatus, and then permits the external apparatus to use the apparatus based on the received password.

In recent years, information processing apparatuses having a biometric authentication function, which performs authentication by using a biometric authentication device, have come to be used. However, there may be a difference in authentication function between a plurality of information processing apparatuses connected to the network. For example, there may be a case where some information processing apparatuses have the biometric authentication function and others do not.

In this case, an information processing apparatus having the biometric authentication function may include a device for inputting biometric information to be used for biometric authentication (hereafter, this device is referred to as biometric information input device), and an information processing apparatus not having the biometric authentication function may not include a biometric information input device.

Such a difference in authentication function between information processing apparatuses causes the following problem. When a local information processing apparatus not having the biometric authentication function accesses an external information processing apparatus having the biometric authentication function, the local information processing apparatus may be requested to transmit biometric information by the external apparatus.

In this case, since the local information processing apparatus accessing the external apparatus does not include a device for inputting the requested biometric information, the biometric information cannot be input.

Therefore, when an information processing apparatus including a biometric information input device is accessed from an information processing apparatus not including a biometric information input device, the former apparatus may permit access from the latter apparatus without performing authentication. In this case, however, the security will be degraded.

On the other hand, if an information processing apparatus including a biometric information input device uniformly prohibits access from an information processing apparatus not including a biometric information input device, the convenience will be degraded.

### SUMMARY OF THE INVENTION

According to an aspect of the present invention, an information processing apparatus capable of receiving access from an external apparatus includes a determination unit configured to determine whether access from the external apparatus is permitted based on biometric information, a printing unit configured to print a permit, a printing control unit configured to instruct the printing unit to print a permit including the biometric information, a receiving unit configured to receive the biometric information included in the permit printed by the printing unit from the external apparatus, and a control unit configured to permit access from the external apparatus if it is determined that access from the external apparatus is permitted based on biometric information received by the receiving unit in a case where an access request is received from the external apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing system according to an exemplary embodiment of the present invention.

FIG. 2 is a block diagram illustrating a configuration of a multifunction peripheral (MFP) 101 in FIG. 1.

FIG. 3 is a block diagram illustrating a configuration of an MFP 102 in FIG. 1.

FIG. 4 is a block diagram illustrating a configuration of a single-function peripheral (SFP) 103 in FIG. 1.

FIG. 5 illustrates an exemplary operation screen of an MFP 101, an MFP 102, and an SFP 103 in FIG. 1.

FIG. 6 illustrates an exemplary operation screen of the MFP 101, the MFP 102, and the SFP 103 in FIG. 1.

FIG. 7 illustrates an exemplary software keyboard that can be displayed by an image processing apparatus according to an exemplary embodiment of the present invention.

FIG. 8 illustrates a screen 801, which prompts a user to perform fingerprint authentication when the MFP 101 in FIG. 1 performs fingerprint authentication.

FIG. 9 illustrates an exemplary BOX screen that can be displayed by the image processing apparatus according to an exemplary embodiment of the present invention.

FIG. 10 is a flow chart illustrating an example data processing procedure by the image processing apparatus according to an exemplary embodiment of the present invention.

FIG. 11 illustrates a remote apparatus selection screen 1101 displayed on a display device 217 of the MFP 101 in FIG. 1.

FIG. 12 illustrates a list screen 1201 of remote apparatuses displayed on the display device 217 of the MFP 101 in FIG. 1.

FIG. 13 illustrates a registration screen 1301 for a temporary password displayed on the display device 217 of the MFP 101 in FIG. 1.

FIG. 14 illustrates an exemplary management table 1501 stored in a mass storage unit 213 in FIG. 1.

FIG. 15 illustrates an exemplary access permit printed by a printer device 206 in FIG. 2.

FIG. 16 is a flow chart illustrating an exemplary data processing procedure by the image processing apparatus according to the present exemplary embodiment.

FIG. 17 illustrates a password authentication screen 1901 displayed on a display device 317 of the MFP 102 in FIG. 1.

FIG. 18 illustrates an exemplary access refusal message displayed on the display device 317 of the MFP 102 in FIG. 1.

FIG. 19 illustrates an exemplary access refusal message displayed on the display device 317 of the MFP 102 in FIG. 1.

FIG. 20 illustrates an exemplary access screen displayed on the display device 317 of the MFP 102 in FIG. 1.

### DESCRIPTION OF THE EMBODIMENTS

Various exemplary embodiments, features, and aspects of the invention will be described in detail below with reference to the drawings.

A first exemplary embodiment of the present invention will be described in detail below with reference to the accompanying drawings.

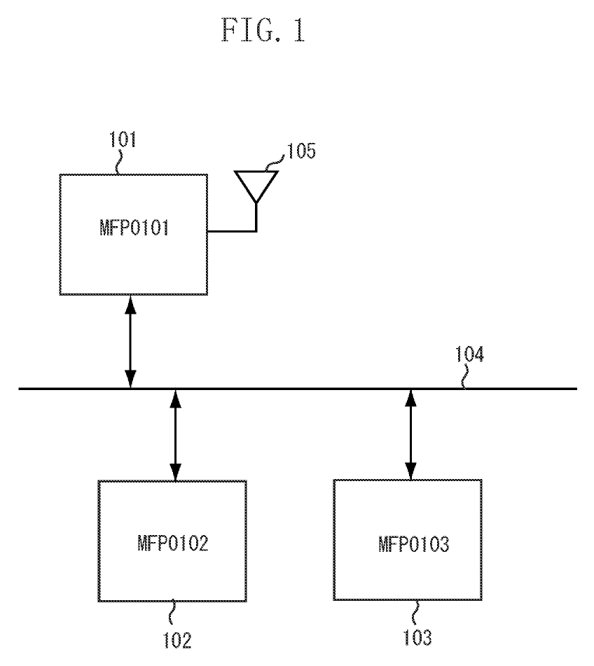

FIG. 1 is a block diagram illustrating a configuration of an image processing system, which is an exemplary information processing system, according to an exemplary embodiment of the present invention. In the present exemplary embodiment, a multifunction peripheral (MFP) will be described as an exemplary information processing apparatus.

Referring to FIG. 1, the image processing system includes a multifunction peripheral (MFP) 101, an MFP 102, and a single-functional peripheral (SFP) 103, which are exemplary information processing apparatuses connected via a network 104. The MFP 101 is connected to a communication line 105 such as a telephone line.

The MFP 101 is a multifunction peripheral having a printer function, a copy function, a facsimile function, and a BOX function. The BOX function is a function that stores image data in memory (such as a hard disk drive (HDD)) of the MFP 101, receives an image data output instruction from the user, and then outputs image data specified by the received image data output instruction. This function will be described in detail below.

The MFP 101 includes a password-based authentication function. The MFP 101 also includes a fingerprint authentication function, which authenticates a user based on fingerprint information. The MFP 101 is configured to receive access from the MFP 102 via the network 104. When the MFP 101 is accessed by the MFP 102, the MFP 101 requests the MFP 102 to transmit biometric information thereto.

The MFP 102 is a multifunction peripheral having the printer function, the copy function, and the BOX function. The MFP 102 includes a password-based authentication function but does not include the fingerprint authentication function, which authenticates a user based on fingerprint information. The SFP 103 is a printer having the printer function. The SFP 103 has only the password-based authentication function as an authenticating method.

The print function of the above-mentioned MFP or SFP may be configured based either on an electrophotographic process or inkjet process. Further, the network 104 may be configured based either on cable communication or wireless communication.

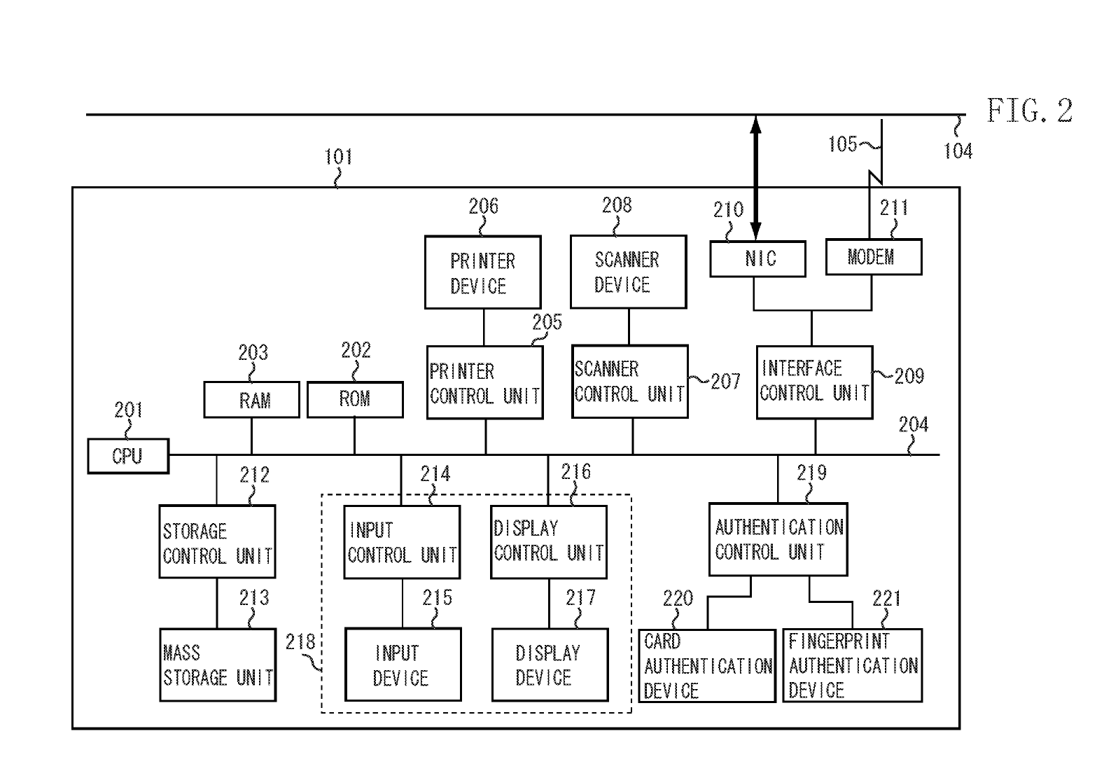

FIG. 2 is a block diagram illustrating a configuration of the MFP 101 in FIG. 1. Referring to FIG. 2, a central processing unit (CPU) 201 controls the entire MFP 101. For example, the CPU 201 activates an operating system (OS) by using a boot program stored in a read-only memory (ROM) 202.

The CPU 201 executes on the OS a controller program and various application programs stored in the mass storage unit 213. The CPU 201 also writes data to a random access memory (RAM) 203, writes data to the mass storage unit 213 via a storage control unit 212, and performs printing control for a printer control unit 205.

The CPU 201 is connected with each unit via a data bus 204. The RAM 203 operates as a main memory of the CPU 201 and a temporary storage area such as a work area. The RAM 203 is also used as a temporary storage area for image processing.

A printer control unit 205 controls a printer device 206 to print image data on a sheet. A scanner control unit 207 controls a scanner device 208 to acquire image data. The scanner device 208 reads image information on a paper sheet by using an optical reading device such as a charge-coupled device (CCD) and then converts it to electrical signal data.

An interface control unit 209 controls a network interface (I/F) of a network interface card (NIC) 210 to perform image data transmission/reception control for the network 104. Further, the interface control unit 209 controls a modem 211 to perform data transmission/reception for a telephone line.

The storage control unit 212 controls data reading from and data writing to the mass storage unit 213. The mass storage unit 213 is a storage device such as a HDD that data can be read from and written into.

The mass storage unit 213 stores a control program for controlling the entire system, application programs, scanned image data, and other various data. The mass storage unit 213 is configured to allow image data stored therein to be accessed from the MFP 102 and MFP 103, which are exemplary external information processing apparatuses.

Further, the mass storage unit 213 stores authentication information for authenticating a user who can access the MFP 101 in relation to the user. The CPU 201 authenticates a user based on the authentication information stored in relation to the user.

An operation unit 218 includes an input control unit 214, an input device 215, a display control unit 216, and a display device 217. The input control unit 214 receives a user operation instruction from the input device 215 such as a touch panel and a hardware keyboard. The display control unit 216 controls the display device 217 such as a liquid crystal display unit to display a display screen such as an operation screen and a message display screen.

The authentication control unit 219 controls a card authentication device 220 and an authentication device such as a fingerprint authentication device 221.

The card authentication device 220 reads a user ID from an ID card in which user information is recorded. The fingerprint authentication device 221 includes a fingerprint information reading portion, which reads user fingerprint information.

The CPU 201 receives the user ID and the fingerprint information read by the card authentication device 220 and the fingerprint authentication device 221 and then authenticates a user based on authentication information for each user stored in the mass storage unit 213.

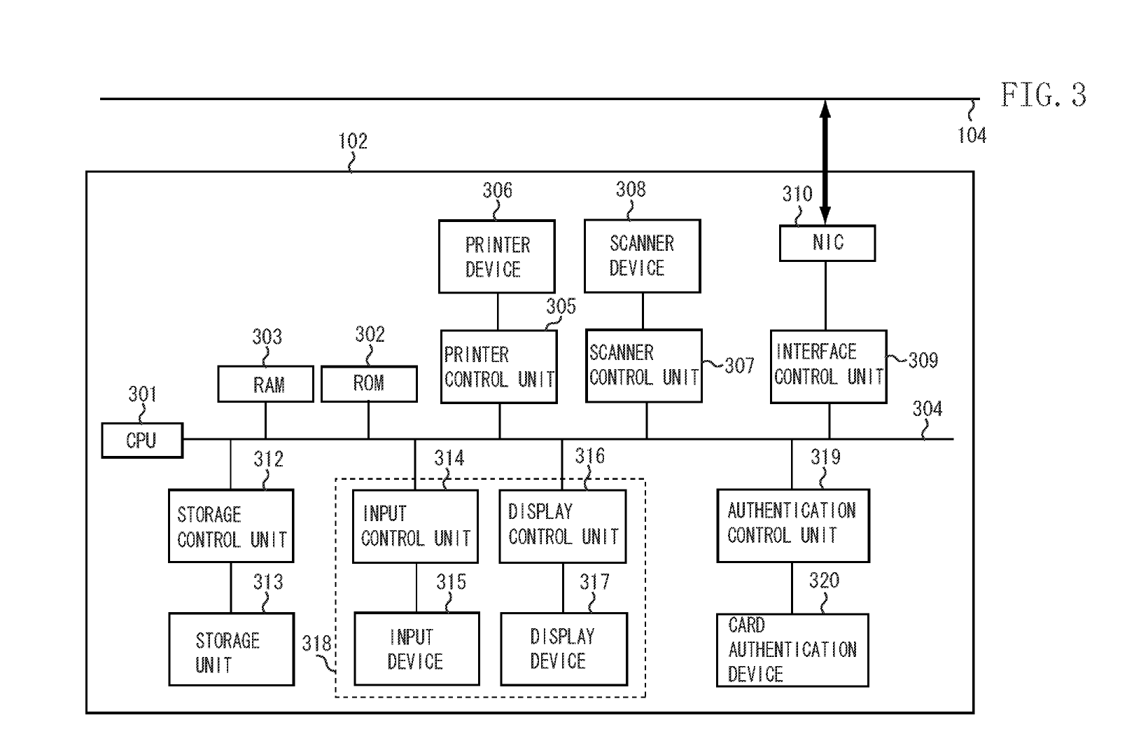

FIG. 3 is a block diagram illustrating a configuration of the MFP 102 in FIG. 1. Referring to FIG. 3, a CPU 301 controls the entire MFP 102. For example, the CPU 301 activates an operating system (OS) by using a boot program stored in a ROM 302.

The CPU 301 executes on the OS a controller program and various application programs stored in a storage unit 313. The CPU 301 also performs control for storing data in a RAM 303 and the storage unit 313.

The CPU 301 is connected with each unit via a data bus 304. The RAM 303 operates as a main memory of the CPU 301 and a temporary storage area such as a work area. The RAM 303 is also used as a temporary storage area for image processing.

A printer control unit 305 controls a printer device 306 to print image data on a sheet.

A scanner control unit 307 controls a scanner device 308 to acquire image data. The scanner device 308 reads image information on a paper sheet by using an optical reading device such as a CCD and then converts it to electrical signal data.

An interface control unit 309 controls a network I/F of a NIC 310 to perform image data transmission/reception control for the network 104.

A storage control unit 312 controls data reading from and data writing to the storage unit 313. The storage unit 313 is a storage device such as a HDD that data can be read from and written to.

The storage unit 313 stores a control program for controlling the entire system, application programs, scanned image data, and other various data.

The operation unit 318 includes an input control unit 314, an input device 315, a display control unit 316, and a display device 317. The input control unit 314 receives a user operation instruction from the input device 315 such as a touch panel and a hardware keyboard.

The display control unit 316 controls the display device 317 such as a liquid crystal display unit to display a screen such as an operation screen and a message display screen. An authentication control unit 319 controls a card authentication device 320. The card authentication device 320 reads a user ID from an ID card in which the user information is recorded.

The CPU 301 receives the user ID read by the card authentication device 320 and then authenticates a user based on the authentication information for each user stored in the storage unit 313.

Unlike the MFP 101, the MFP 102 does not include the fingerprint authentication device 221. That is, there is a difference in authentication function between the MFP 102 and the MFP 101.

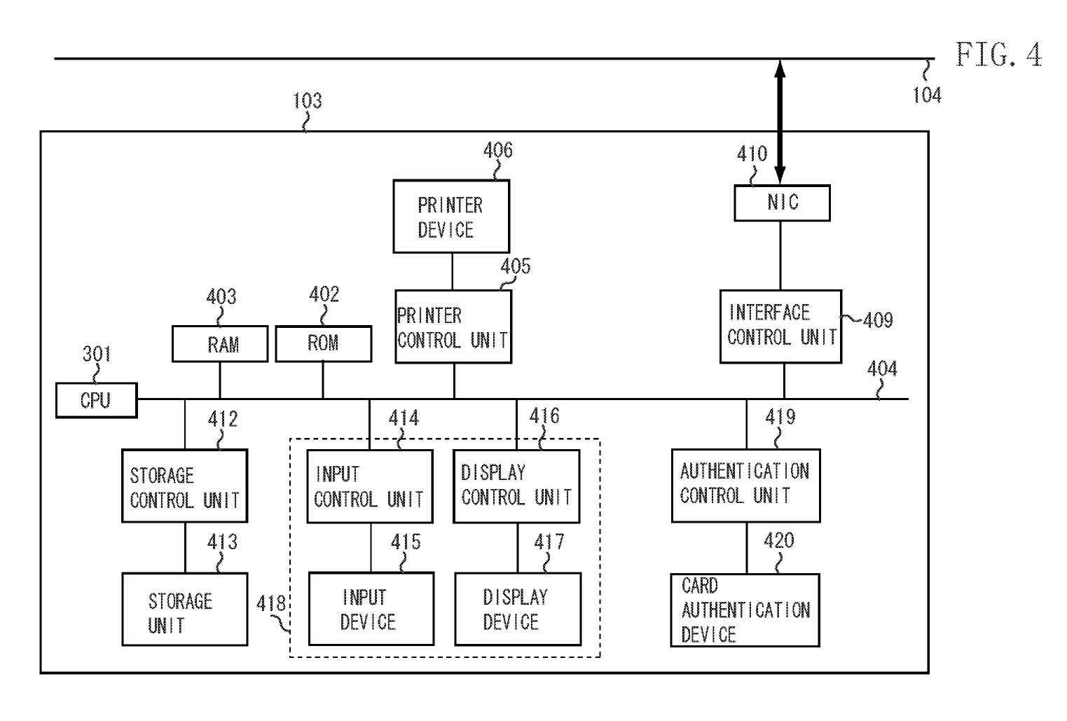

FIG. 4 is a block diagram illustrating a configuration of the SFP 103 in FIG. 1. Referring to FIG. 4, a CPU 401 controls the entire SFP 103. For example, the CPU 401 activates an operating system (OS) by using a boot program stored in a ROM 402.

The CPU 401 executes on the OS a controller program and various application programs stored in a storage unit 413. The CPU 401 also performs control for storing data in a RAM 403 and the storage unit 413.

The CPU 401 is connected with each unit via an internal data bus 404. The RAM 403 operates as a main memory of the CPU 401 and a temporary storage area such as a work area. The RAM 403 is also used as a temporary storage area for image processing.

A printer control unit 405 controls a printer device 406 to print image data on a sheet. An interface control unit 409 controls a network I/F of a NIC 410 to perform image data transmission/reception control for the network 104.

The storage control unit 412 controls data reading from and data writing to the storage unit 413. The storage unit 413 is a storage device that data can be read from and written into. The storage unit 413 stores a control program for controlling the entire system, application programs, scanned image data, and other various data.

An operation unit 418 includes an input control unit 414, an input device 415, a display control unit 416, and a display device 417. The input control unit 414 receives a user operation instruction from the input device 415 such as a touch panel and a hardware keyboard. The display control unit 416 controls the display device 417 such as a liquid crystal display unit to display a screen such as an operation screen and a message display screen.

An authentication control unit 419 controls a card authentication device 420. The card authentication device 420 reads a user ID from an ID card in which the user information is recorded.

Unlike the MFP 101 and MFP 102, the SFP 103 does not include the scanner function as mentioned above. Accordingly, the SFP 103 does not include the scanner control unit 307 or the scanner device 308.

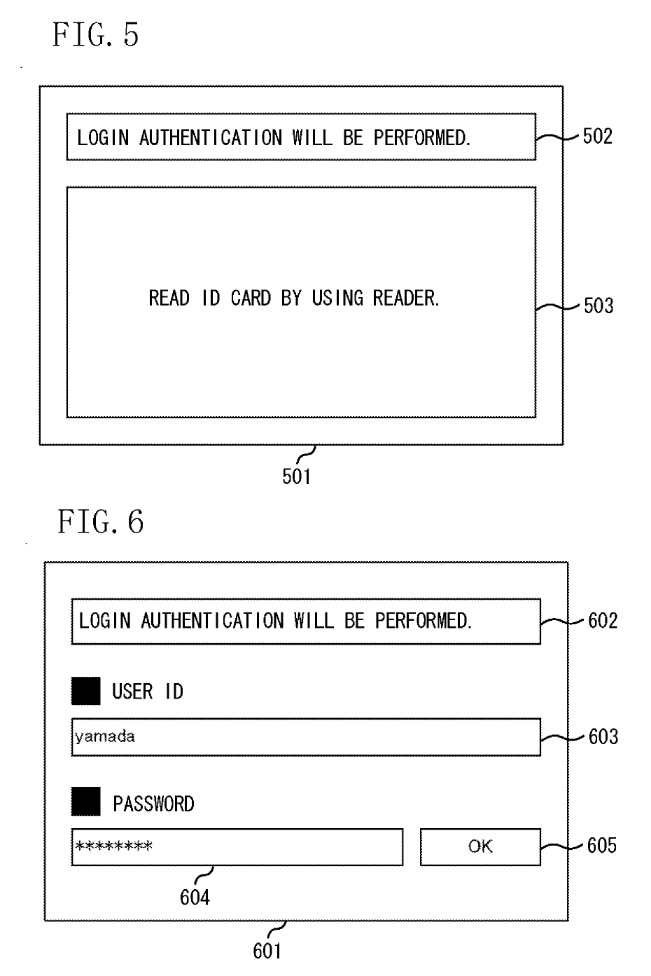

FIGS. 5 and 6 illustrate exemplary operation screens displayed on the display devices included in the MFP 101, the MFP 102, and the SFP 103 in FIG. 1. The CPU of the MFP 101, the MFP 102, and the SFP 103 displays these screens on the display device of each apparatus.

Referring to FIG. 5, a screen 501 prompts the user to read an ID card, as illustrated in screen portions 502 and 503. When the user operates the card authentication device 220 to read the ID card, the CPU of each apparatus inputs a user ID into a user ID input field 603 on a screen 601 in FIG. 6.

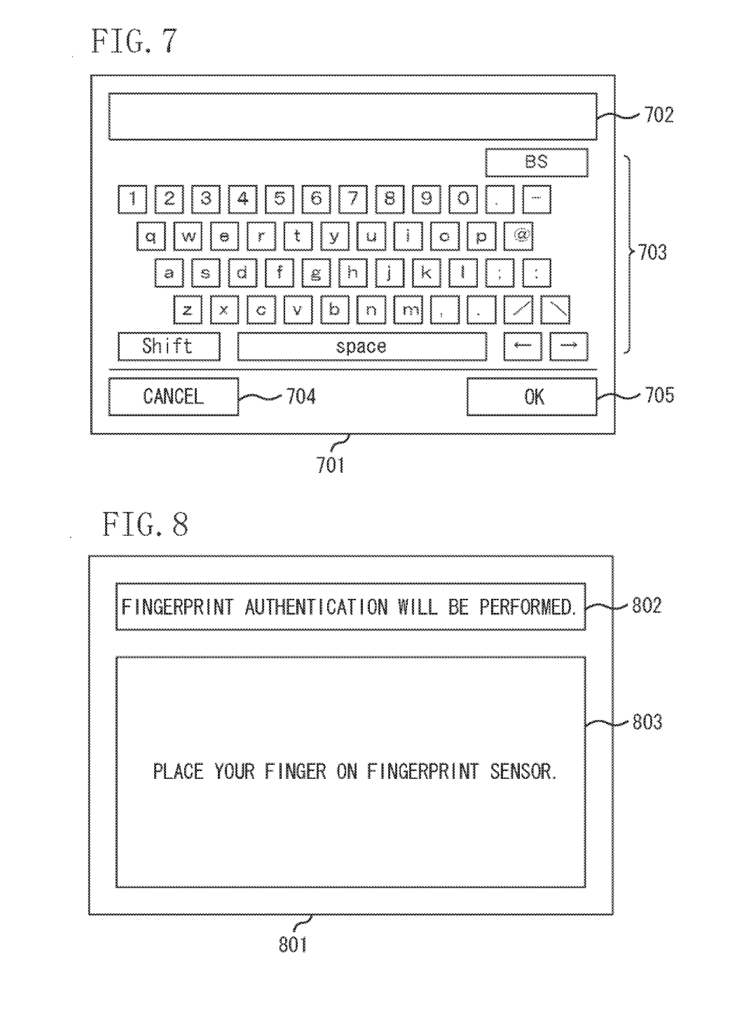

Then, the user inputs a password in a password input field 604. In this case, the user inputs a password through a software keyboard 701 in FIG. 7.

The user operates keys 703 on the software keyboard 701 to input a password. When the user inputs a password, the input characters are displayed in an input character string display field 702. When the user presses an OK button 705 on the software keyboard 701, the software keyboard 701 is closed and then the input characters are reflected to the password input field 604.

When the user presses a CANCEL button 704 on the software keyboard 701, the screen of the software keyboard 701 is closed without reflecting the input characters to the user ID input field 603.

However, the password input field 604, and the input character string display field 702 on the software keyboard 701 display asterisks “*” of the number of input characters to mask the characters input by the user.

When the user inputs a password corresponding to the user ID and then presses an OK button 605, the CPU of each apparatus performs authentication processing based on the input password.

If authentication is successfully completed, the CPU of each apparatus displays an operation screen to allow the user to use the function of the MFP 101. On the other hand, if user authentication fails, an error message “COULD NOT COMPLETE” is displayed.

FIG. 8 illustrates a screen 801, which prompts the user to perform fingerprint authentication, when the MFP 101 in FIG. 1 performs fingerprint authentication. The CPU 201 of the MFP 101 displays the screen 801 on the display device 217.

The CPU 201 displays the screen in FIG. 8 to prompt the user to input fingerprint information by touching with a finger the fingerprint information reading portion (fingerprint sensor) of the fingerprint authentication device 221.

Then, the CPU 201 acquires fingerprint information through the fingerprint authentication device 221. Then, the CPU 201 compares the acquired fingerprint information with user fingerprint information stored in the mass storage unit 213 beforehand.

As a result of the comparison, if the CPU 201 determines that both pieces of the fingerprint information belong to an identical user, the CPU 201 permits the user to use the MFP 101. Then, the user can use the function of the MFP 101 from the operation unit 218 of the MFP 101.

In the present exemplary embodiment, fingerprint authentication is performed when the user uses the function of the MFP 101 from the operation unit 218 of the MFP 101. However, a timing of fingerprint authentication is not limited thereto. For example, fingerprint authentication may be performed when the user uses the BOX function included in the MFP 101. In this case, the user performs control as described below.

First of all, the user displays a BOX screen for using the BOX function on the display device 217. The BOX screen is used to perform operations for using the BOX function included in the MFP 101. The user performs operations for the data stored in the mass storage unit 213 of the MFP 101 through the BOX screen.

The mass storage unit 213 includes a plurality of storage areas, each being referred to as BOX. Data can be stored in each storage area.

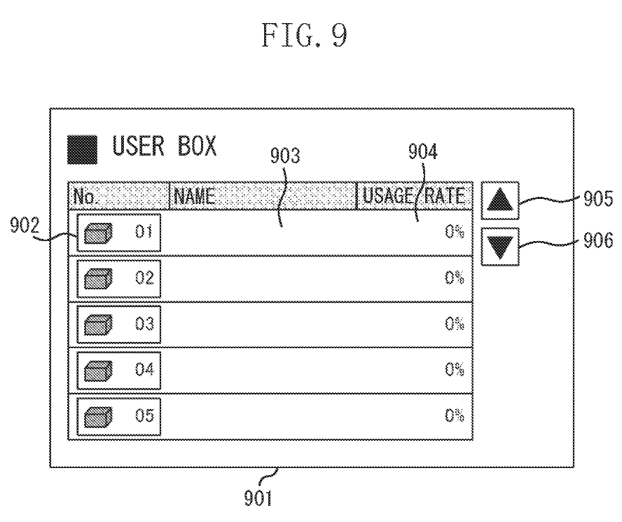

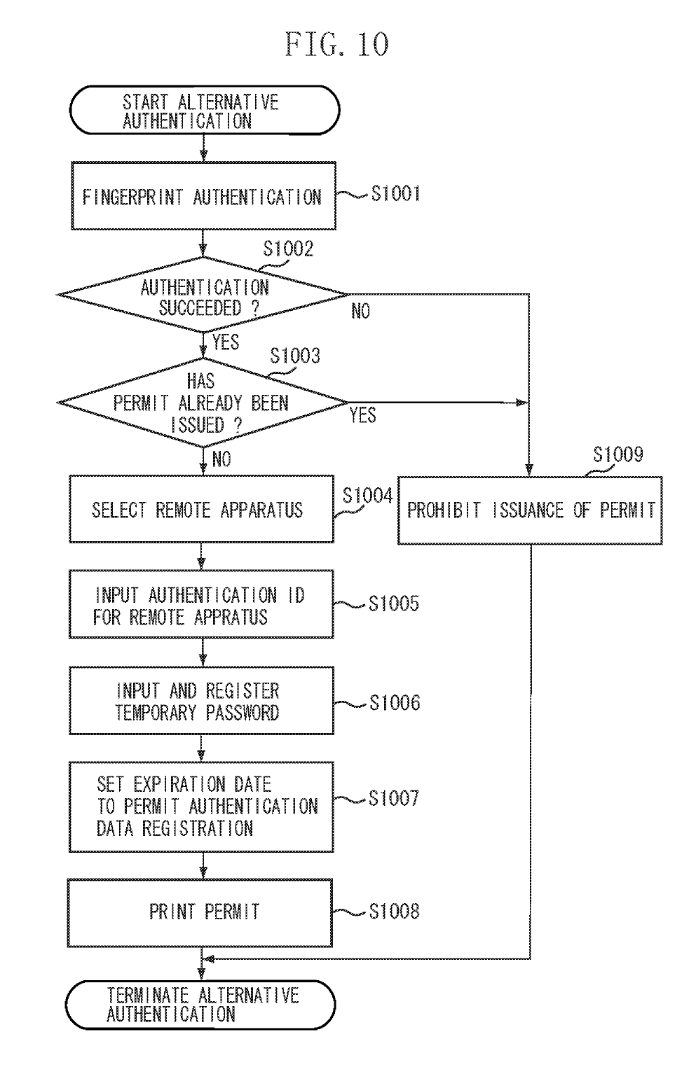

FIG. 9 is an exemplary BOX screen. As illustrated in FIG. 9, a BOX screen 901 displays a BOX number 902, a BOX name 903, a usage rate 904, and scroll buttons 905 and 906. When the user selects a desired BOX out of the BOXes, the user can access the selected BOX and refer to the data stored in the BOX.

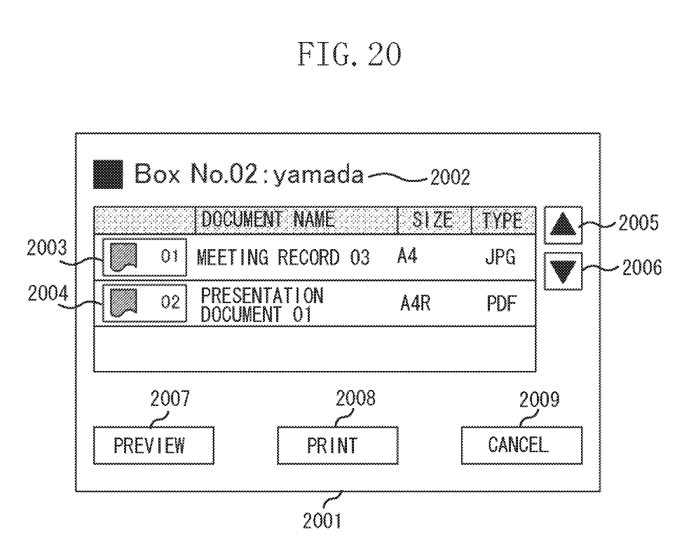

When the user selects the BOX number “02”, the CPU 201 displays an exemplary screen 2001 in FIG. 20 on the display device 217. The box with the BOX number “02” stores data of two different documents (image data). When the user selects a desired document and then presses a PRINT button 2008, the data of the desired document can be printed.

When the user selects a desired document and then presses a PREVIEW button 2007, the data of the desired document can be displayed on the display device 217 as image data. The BOX function can be used in this way.

Each BOX can be managed in relation to each user. Further, the user can make setup to perform authentication such as fingerprint authentication for accessing each BOX. With this authentication setup, the CPU 201 performs control to request the user to perform authentication by using fingerprint information when each BOX is selected.

For example, when fingerprint authentication is set to access the BOX number “02”, the CPU 201 requests the user to input fingerprint information when the user selects the BOX number “02.” In this case, when the BOX with the BOX number “02” is accessed from the operation unit 218, the CPU 201 requests the user to input fingerprint information through the operation unit 218.

On the other hand, when the BOX with the BOX number “02” is accessed from the operation unit 318 of the MFP 102, the CPU 301 requests the user to input fingerprint information through the operation unit 318. When the user inputs fingerprint information, the CPU 301 permits the user to access the BOX (use the BOX with the BOX number “02”).

That is, the user can refer to the data stored in the BOX with the BOX number “02.” The screen 2001 in FIG. 20 is displayed on the operation unit 218 or 318.

With the configuration of the above-mentioned image processing system, a case where the MFP 102 not including a fingerprint authentication device accesses the MFP 101 including a fingerprint authentication device is assumed.

When a user requests access through the operation unit 218 of the MFP 101, the MFP 101 displays the screens of FIGS. 5 to 8 and then acquires a user ID, a password, and fingerprint information to authenticate the user.

If user authentication is successfully completed, the MFP 101 displays an operation screen (for example, the screen 901 in FIG. 9) for operating the MFP 101. The user can use the copy function by using the scanner device 208 and the printer device 206 of the MFP 101 through the displayed screen, and the BOX function through the screen 901 in FIG. 9.

For example, when the user accesses the MFP 101 from the MFP 102, the MFP 101 receives access from the MFP 102 (external apparatus) via the network 104. In this case, the MFP 101 requests the user to input a user ID, a password, and fingerprint information also for access from the MFP 102.

However, since the MFP 102 does not include a fingerprint authentication device, it cannot acquire fingerprint information from the user by using a fingerprint authentication device.

In response to an access request from the MFP 102, if the MFP 101 permits the MFP 102 to access it based on a user ID and a password without performing authentication processing by using fingerprint information, the security will be degraded.

In response to an access request from the MFP 102, if the MFP 101 uniformly prohibits the MFP 102 from accessing it, the user cannot access the MFP 101 from the MFP 102 resulting in reduced convenience.

Therefore, when the MFP 101 receives an access request from an external apparatus not including a fingerprint authentication device, the MFP 101 performs control instead of acquiring user fingerprint information by using a fingerprint authentication device.

The CPU 201 of the MFP 101 instructs the printer device 206 to print information indicating fingerprint information on a sheet to issue a permit including fingerprint information.

If the user wants to access the MFP 101 from an MFP that does not include a fingerprint authentication device, such as the MFP 102, the user instructs the scanner device 308 of the MFP 102 to read the issued permit. Then, the CPU 301 of the MFP 102 transmits the information read by the scanner device 308 to the MFP 101.

The CPU 201 of the MFP 101 authenticates a user based on the user fingerprint information included in the information transmitted from the MFP 102. If user authentication is successfully completed, the CPU 201 permits the user to access the MFP 101 from the MFP 102.

On the other hand, if fingerprint information is not transmitted from the MFP 102 or authentication based on fingerprint information fails, the CPU 201 prohibits the user from accessing the MFP 101 from the MFP 102.

Control by the MFP 101 and control by the MFP 102 will be described in detail below. First of all, permit print processing performed by the MFP 101 will be described below with reference to a flow chart in FIG. 10.

FIG. 10 is a flow chart illustrating an exemplary data processing procedure performed by the MFP 101 according to the present exemplary embodiment. Each step is attained when the CPU 201 of the MFP 101 loads the control program stored in the ROM 202 or the mass storage unit 213 into the RAM 203 and then executed it.

The MFP 101 starts the flow chart in FIG. 10 when the CPU 201 of the MFP 101 receives a request to issue a permit from the user through the operation unit 218.

In step S1001, the CPU 201 acquires user fingerprint information through the fingerprint authentication device 221 in FIG. 2, and performs fingerprint authentication. In step S1002, the CPU 201 determines whether or not user authentication based on fingerprint information is successfully completed. Specifically, the CPU 201 determines whether or not the acquired fingerprint information belongs to a registered user.

If the CPU 201 does not determine that the acquired fingerprint information belongs to a registered user (NO in step S1002), the processing advances to step S1009 to refuse printing of the permit, that is, the CPU 201 prohibits access from the MFP 102.

On the other hand, if the CPU 201 determines that the acquired fingerprint information belongs to a registered user (YES in step S1002), the processing advances to step S1003.

In the above-mentioned case, the CPU 201 performs fingerprint authentication by using fingerprint information in step S1001. However, the CPU 201 may perform user authentication by using non-biometric information such as fingerprint information.

A password is an example of non-biometric information. In this case, if password-based user authentication is successfully completed, the processing advances to step S1003. On the other hand, if password-based user authentication fails, the processing advances to step S1009.

In step S1003, the CPU 201 determines whether or not a permit has already been issued (printed) for an identical user. If the CPU 201 determines that a permit has already been printed (YES in step S1003), it refuses or restricts printing of the permit in step S1009 and then terminates the processing. This prevents the permit from being endlessly issued even if user authentication is successfully completed.

The CPU 201 may perform control to permit printing of the permit a predetermined number of times (for example, twice or three times). In this case, in step S1003, the CPU 201 determines whether or not printing has already been performed the predetermined number of times. If the CPU 201 determines that printing has already been performed the predetermined number of times (YES in step S1003), the processing advances to step S1009.

If the CPU 201 does not determine that printing has already been performed the predetermined number of times (NO in step S1003), the processing advances to step S1004. The predetermined number of times may be changed depending on the user.

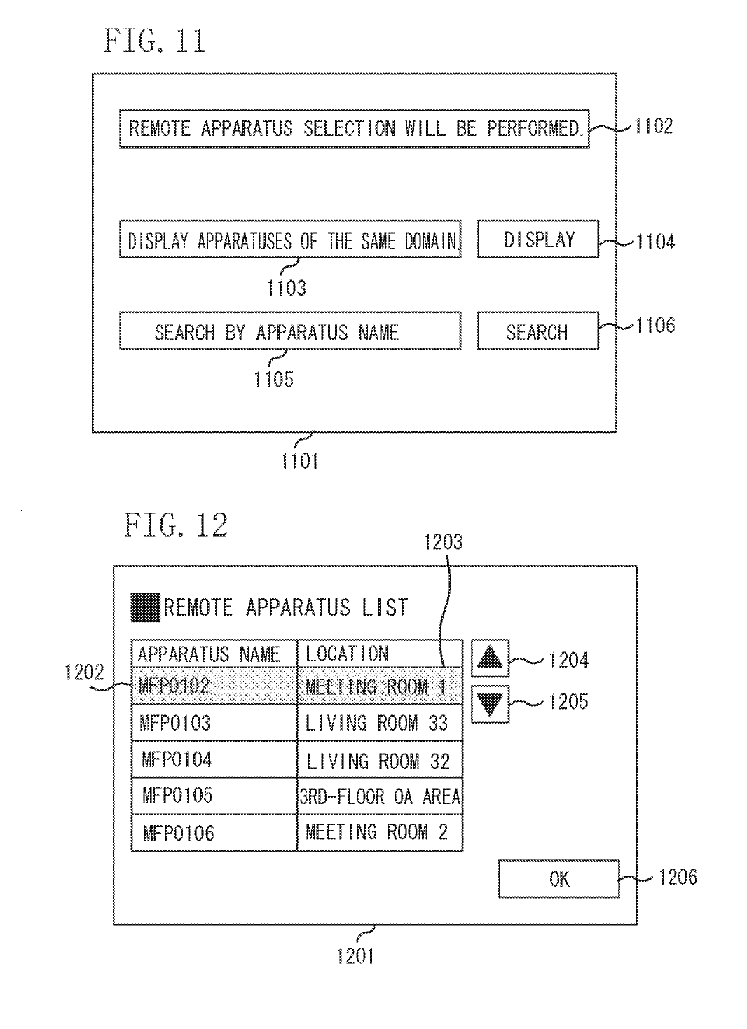

If the CPU 201 determines that a permit can still be issued (NO in step S1003), the processing advances to step S1004. In step S1004, the CPU 201 displays the screen in FIG. 11 on the display device 217 and then receives from the user a selection of an external apparatus (remote apparatus) that accesses the MFP 101.

FIG. 11 illustrates the remote apparatus selection screen 1101 displayed on the display device 217 of the MFP 101 in FIG. 1.

Referring to FIG. 11, the user displays a list of apparatuses (remote apparatuses), which belong to the same domain by using a display field 1103 and a button 1104. The user searches for a desired apparatus by specifying an apparatus name using a display field 1105 and a button 1106.

Apparatus search is not necessarily based on a user-input apparatus name, but the user may make apparatus search by using a parameter other than an apparatus name. Further, the user may search for an apparatus by transmitting a broadcasting packet to apparatuses and receiving a response therefrom.

FIG. 12 illustrates the list screen 1201 of remote apparatuses displayed on the display device 217 of the MFP 101.

Referring to FIG. 12, the list screen 1201 displays an apparatus name 1202 and an apparatus installation location 1203. The user can scroll the screen by using scroll buttons 1204 and 1205. With this screen, the user selects, for example, a MFP 0102 and then presses an OK button 1206.

When the user presses the OK button 1206 with a remote apparatus selected from the list screen 1201, the CPU 201 stores the selected remote apparatus in the mass storage unit 213.

In step S1005, the CPU 201 prompts the user to input a password to be used to authenticate the user in the apparatus (remote apparatus) selected by the user. In step S1005, the CPU 201 instructs the selected apparatus to transmit a password registered in relation to the user within the selected apparatus.

In step S1005, if the password input by the user differs from the one transmitted from the selected apparatus, the CPU 201 terminates processing without performing processing of step S1006 and subsequent steps.

On the other hand, if the password input by the user coincides with the one transmitted from the selected apparatus, the CPU 201 performs processing of step S1006 and subsequent steps.

In step S1006, the CPU 201 receives from the user a temporary password to be used to permit a permit-based access from an external apparatus and registers it to the mass storage unit 213.

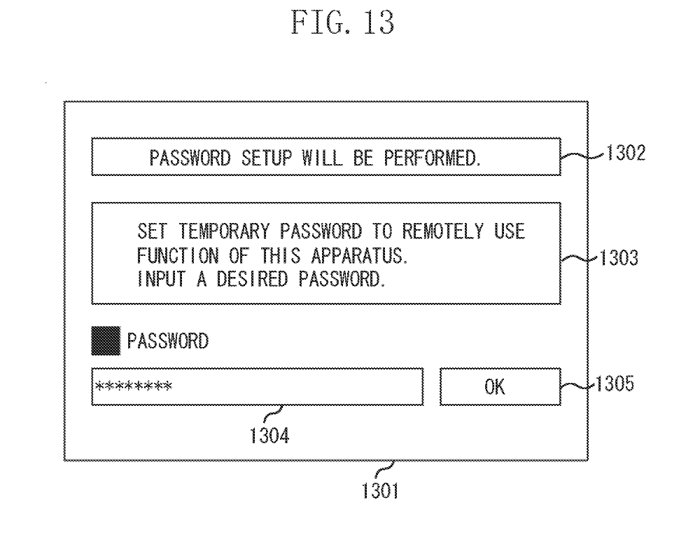

FIG. 13 illustrates the registration screen 1301 of the temporary password displayed on the display device 217 of the MFP 101.

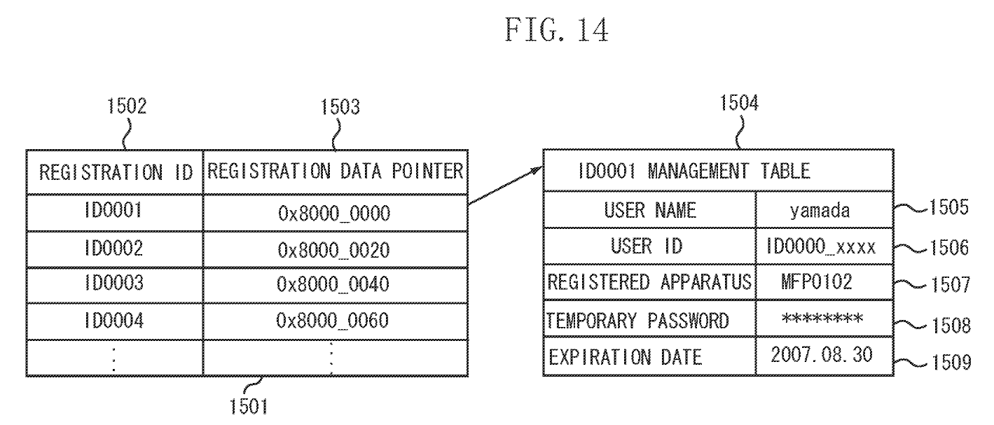

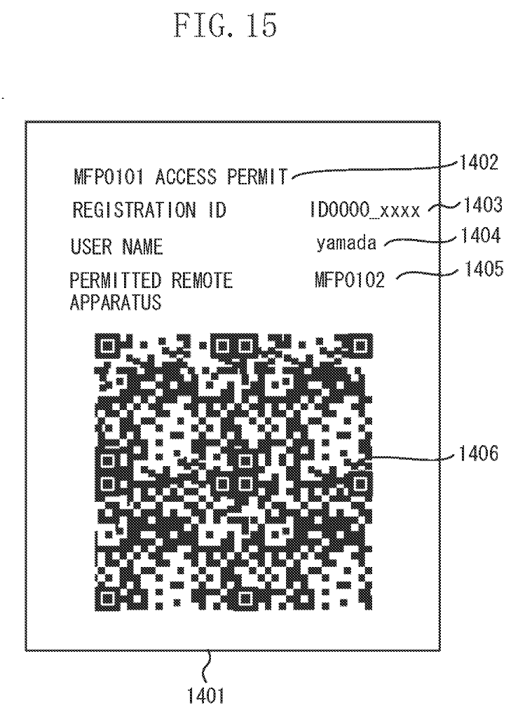

The user inputs a desired password in a password input field 1304 and then presses an OK button 1305. The management table 1501 in FIG. 14 stored in the mass storage unit 213 manages the password input in step S1006 and the information regarding the remote apparatus selected in step S1004.

Referring to FIG. 14, the management table 1501 includes a registration ID 1502 and a registration data pointer 1503. The registration ID 1502 is automatically assigned by the CPU 201 each time a permit is issued. The registration data pointer 1503 points the details of registration for each registration ID.

A management table 1504 shows registered contents of the registration ID 0001. The management table 1504 manages the details of a registration ID 0001. The location storing the management table 1501 is not limited to the mass storage unit 213 in FIG. 1.

The management table 1504 includes a user name 1505 and a user ID 1506. The CPU 201 inputs the user name 1505 and the user ID 1506 based on a user ID of the user identified in authentication performed in step S1001 by the MFP 101. The user name 1505 is input by the user and then stored in the mass storage unit 213 when the user ID 1506 is registered to the MFP 101.

The management table 1504 further includes a remote apparatus 1507 registered in step S1004, a temporary password 1508 registered in step S1008 and managed in enciphered manner, and an expiration date 1509 by which access by the registration ID is permitted.

In response to a permit-based access request, the CPU 201 permits access by the access request if the expiration date is not expired or prohibits access by the access request if the expiration date is expired.

The expiration date may be set for each user, or an apparatus administrator may preset a predetermined effective period. In the latter case, the CPU 201 determines that the time period since a permit is issued until the predetermined effective period preset by the apparatus administrator as an expiration date.

Then, the parameters of the management table in FIG. 14 have been determined in steps S1005 to S1007, the CPU 201 stores the above-mentioned details of registration in a storage area in the MFP 101. In step S1008, the CPU 201 prints the permit in FIG. 15 according to the above-mentioned details of registration and then terminates this processing.

FIG. 15 illustrates an example permit. Referring to FIG. 15, an example permit 1401 includes a name 1402 of an apparatus to be accessed, a registered ID 1403, a user name 1404, and a name 1405 of a remote apparatus to be permitted to access the apparatus by the permit 1401.

The example permit 1401 further includes a 2-dimensional bar code 1406 describing the above-mentioned details of registration and fingerprint information of the user who requested to issue the permit 1401. The details of registration includes a registration ID, a user name, a name of a remote apparatus to be permitted to access, and a name of the apparatus to be accessed.

The permit 1401 is printed on a sheet having a size that allows the pieces of information 1401 to 1406 to be printed by the printer device 206 of the MFP 101.

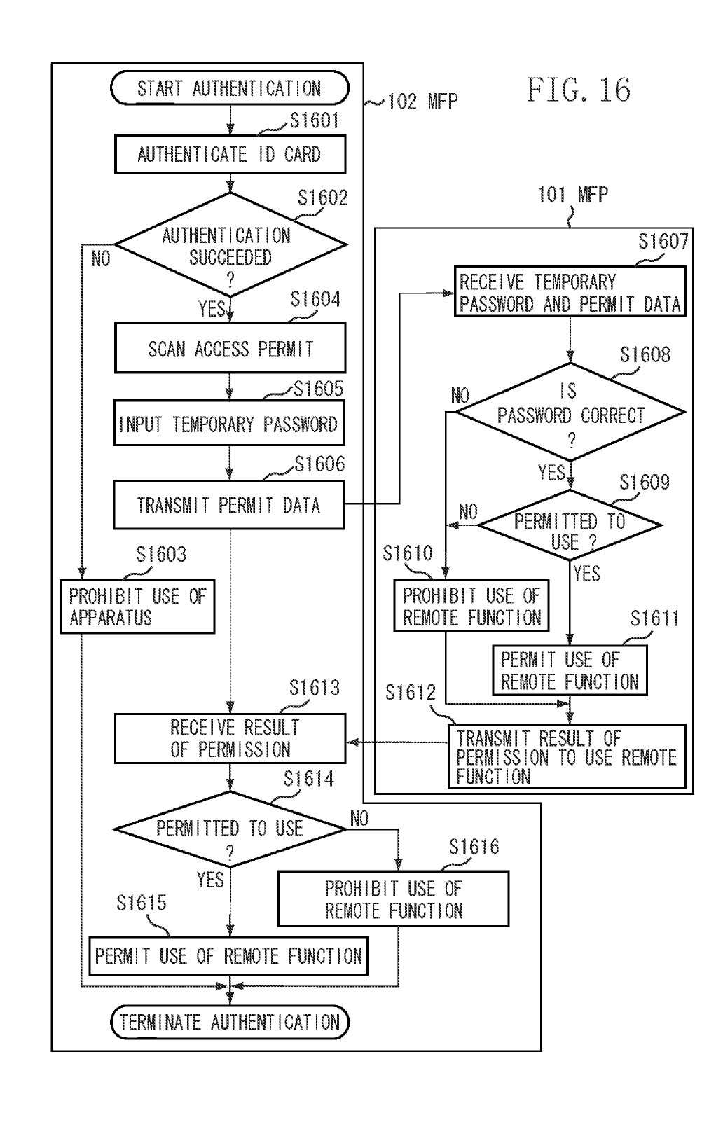

Next, a flow of authentication by the MFP 102 (remote apparatus) will be described with reference to the flow chart in FIG. 16. FIG. 16 is a flow chart of an example data processing procedure performed by the image processing system according to the exemplary embodiment of the present invention.

This procedure performs exemplary authentication processing by the MFP 101 and the MFP 102 in FIG. 1. Steps S1601 to S1606 and S1613 to S1616 are attained when the CPU 301 of the MFP 102 in FIG. 1 loads the control program stored in the storage unit 313 or the ROM 302 into the RAM 303 and then executes it.

Steps S1607 to S1612 are attained when the CPU 201 of the MFP 101 loads the control program stored in the ROM 202 or the mass storage unit 213 into the RAM 203 and then executes it.

FIG. 16 illustrates flow charts including a flow of the MFP 102 (remote apparatus) on the left-hand side, and a flow of the MFP 101 on the right-hand side.

First of all, in step S1601, the MFP 102 performs authentication based on an ID card. The CPU 301 authenticates a user by reading a user ID from an ID card through the card authentication device 320 in FIG. 3, and receives a password from the user through the operation unit 218 capable of receiving a password.

In step S1602, the CPU 301 determines whether user authentication is successfully completed. If the CPU 301 does not determine that user authentication has been successfully completed (NO in step S1602), the CPU 301 prohibits the use of local apparatus in step S1603 and then terminates processing.

On the other hand, if the CPU 301 determines that user authentication is successfully completed (YES in step S1602), the processing advances to step S1604. In step S1604, the CPU 301 receives from the user a specified apparatus to be accessed from the MFP 102. In the present exemplary embodiment, the CPU 301 receives from the user the MFP 102 as an apparatus to be accessed.

When the MFP 101 is specified as an apparatus to be accessed, the CPU 301 transmits an access request to the MFP 101. An access request means a request to use the function of the MFP 101 from the operation unit 318 of the MFP 102.

When the MFP 101 receives an access request, the MFP 101 requests the MFP 102 to transmit biometric information.

When the MFP 102 receives a request to transmit biometric information, the CPU 301 of the MFP 102 prompts the user through the display device 317 to set the permit issued by the MFP 101 on a document positioning plate included in the scanner device 308 and then scan it.

When the user sets the permit on the document positioning plate and then the CPU 301 receives a scanning instruction through the operation unit 318 of the MFP 102, the CPU 301 scans the permit by using the scanner device 308. The MFP 102 scans the permit and then generates permit data, which is image data corresponding to the permit.

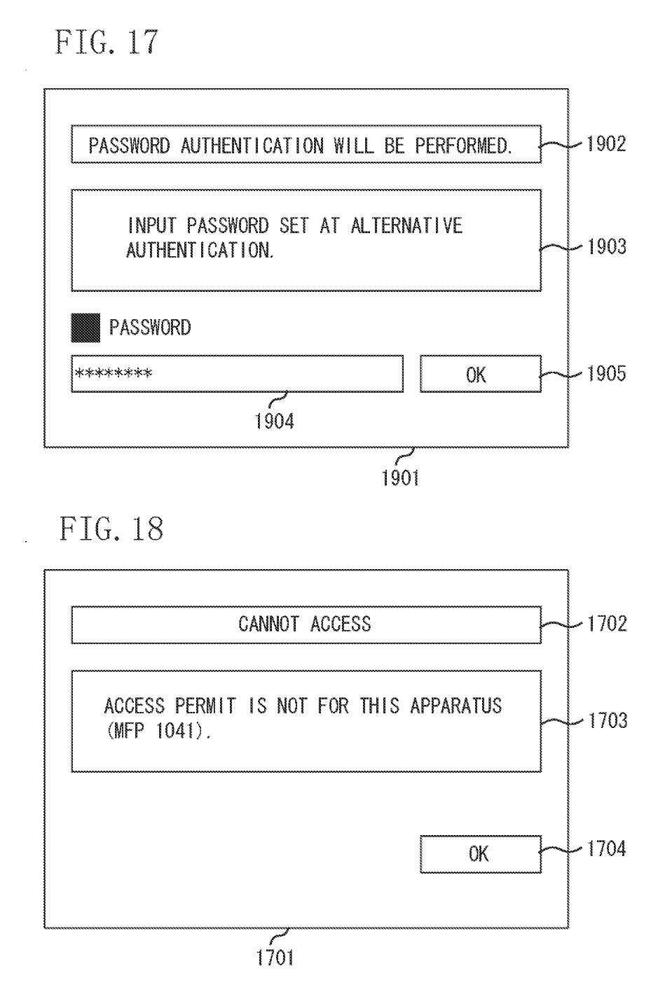

In step S1605, the CPU 301 displays the screen illustrated in FIG. 17 on the display device 317 and then requests the user to input the temporary password set when the permit was issued.

The user operates the input device 315 of the MFP 102 to input the temporary password. The temporary password set when the permit was issued is the one registered in step S1006 in FIG. 10 by the user.

FIG. 17 illustrates a password authentication screen 1901 displayed on the display device 317 of the MFP 102 in FIG. 1. Referring to FIG. 17, the user inputs the temporary password into a password input field 1904 and then presses an OK button 1905.

In step S1606, the CPU 301 transmits the temporary password and the information acquired from the permit to the MFP 101 via the network 104. The permit data acquired from the permit includes a registration ID, a user name, a name of an apparatus to be accessed, a name of a remote apparatus to be permitted to access by the permit, and user biometric information.

In step S1607, the CPU 201 of the MFP 101 receives the temporary password and the permit data transmitted from the MFP 102. When the CPU 201 receives the permit data, the CPU 201 analyzes the received permit data.

For example, the CPU 201 analyzes the 2-dimensional bar code 1406 included in the permit to extract the registration ID, the user name, the name of an apparatus to be accessed, the name of a remote apparatus to be permitted to access by the permit, and user fingerprint information.

In step S1608, the CPU 201 compares the received temporary password with the temporary password corresponding to the registration ID included in the received information, which is managed by the management table 1504. As a result of the comparison, if the CPU 201 does not determine that the received temporary password is correct (NO in step S1608), the processing advances to step S1610 to determine to prohibit access from the MFP 102 and then advances to step S1612.

On the other hand, if the CPU 201 determines that the temporary password is correct (YES in step S1608), the processing advances to step S1609. In step S1609, the CPU 201 determines whether or not access from the MFP 102 is to be permitted based on the information extracted from the permit data.

More specifically, the CPU 201 identifies the registration data pointer 1503 based on the extracted registration ID, and refers to the management table 1504 pointed by the identified registration data pointer 1503. Then, the CPU 201 identifies the user name from the referenced table.

In step S1609, the CPU 201 reads fingerprint information corresponding to the identified user name from the mass storage unit 213 and then compares it with the fingerprint information received in step S1607. As a result of the comparison, if the CPU 201 determines that above-mentioned both pieces of fingerprint information belong to an identical user (YES in step S1609), user authentication has been successfully completed and therefore the processing advances to step S1611.

If the CPU 201 does not determine that above-mentioned both pieces of fingerprint information belong to an identical user (NO in step S1609), user authentication has failed and therefore the processing advances to step S1610. Then, the CPU 201 determines to prohibit access from the MFP 102, and then the processing advances to step S1612.

If the processing advances to step S1611, it determines to permit access from the MFP 102, and then the processing advances to step S1612. In step S1612, the CPU 101 transmits a result of access permission/prohibition from the MFP 102 determined in step S1610 or S1611 to the MFP 102 via the network 104.

In step S1613, the CPU 301 of the MFP 102 receives the result of access permission/prohibition from the MFP 101 via the network 104. In step S1614, the CPU 301 determines whether or not access permission has been obtained.

If the CPU 301 determines that access permission has been obtained by the MFP 101 (YES in step S1614), the processing advances to step S1615. In step S1615, the CPU 301 permits the user to remotely operate the MFP 101, displays a screen for operating the MFP 101 on the operation unit 318 of the MFP 102, for example, and then terminates the authentication processing.

If the CPU 301 does not determine that access permission is obtained from the MFP 101 (NO in step S1614), the CPU 301 prohibits the user from remotely operating the MFP 101 in step S1616 and then terminates the authentication processing.

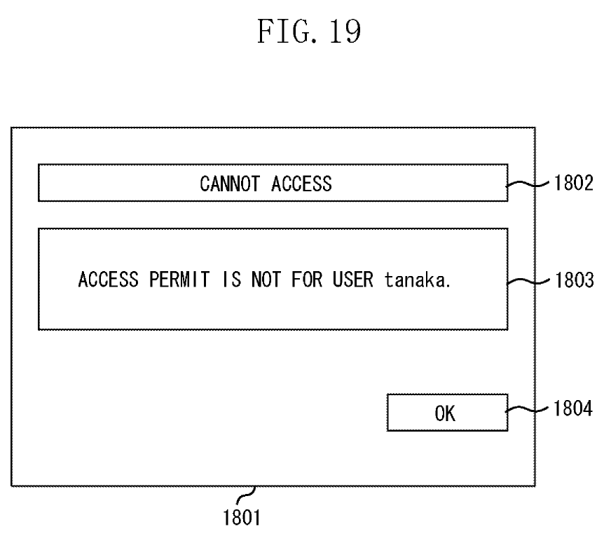

In step S1608, when the CPU 201 prohibits access because of a wrong temporary password, it transmits information for displaying the screen in FIG. 19 notifying that access is prohibited to the MFP 102.

Then, the CPU 201 instructs the CPU 301 of the MFP 102 to display the screen in FIG. 19 on the display device 317, thus allowing the user to be notified of the incorrect temporary password.

In the above-mentioned exemplary embodiment, access is prohibited based on the user fingerprint information included in the 2-dimensional bar code of the permit data and the user fingerprint information stored in the mass storage unit 213. However, the determination of access permission/prohibition may not be limited thereto, and may be controlled in the following manner.

For example, if the apparatus to be accessed, included in the permit data received in step S1607, coincides with the apparatus currently requested an access, the CPU 201 permits access to the MFP 101. On the other hand, if the apparatus to be accessed differs from the apparatus currently requested an access, the CPU 201 prohibits access to the MFP 101.

To prohibit access, the CPU 201 transmits information for displaying a message screen 1701 corresponding to a result of the authentication determination in FIG. 18 to the MFP 102, and then instructs the display device 317 of the MFP 102 to display the message screen 1701. This allows the user to be notified that the permit is not for the MFP 102.

As mentioned above, a user can use the function of the MFP 101 requiring fingerprint authentication from the MFP 102 not including a fingerprint authentication device while maintaining the security as much as possible.

In the above-mentioned exemplary embodiment, the user specifies the MFP 101 as an apparatus to be accessed from the MFP 102 and, if the user is permitted to access the MFP 101, the user is permitted to use the function of the MFP 101. However, the present invention is also applicable to a case where fingerprint authentication is required when a user of the MFP 102 accesses any one of the BOX areas included in the MFP 101.

For example, the user displays the screen 901 illustrated in FIG. 9, i.e., the BOX screen of the MFP 101 on the display device 317 of the MFP 102. Suppose that, when the user requests to access any one of the BOX areas displayed on the BOX screen, a condition of fingerprint information input has been preset for the requested BOX area. In this case, the CPU 201 of the MFP 101 requests the user operating the MFP 102 to input fingerprint information through the display device 317 of the MFP 102.

Then, the user scans the permit, and then transmits the scanned temporary password and permit data to the MFP 101. Then, based on the received temporary password and permit data, the MFP 101 determines whether or not the user is permitted to access the BOX area requested to be accessed, and then transmits a result of the determination to the MFP 102. The procedure for determining whether or not the user is permitted to access the BOX area is the same as that described in steps S1604 to S1616 and therefore detailed descriptions will be omitted.

When the user is permitted to access the BOX area specified by the user, the user can give instructions for previewing and printing the data stored in the BOX area from the operation unit 318 of the MFP 102. Then, the MFP 101 that received these instructions performs operations according to the received instructions.

For example, suppose that the user requests to access a BOX area (“BOX No. 2”) out of the BOX areas of the MFP 101 in FIG. 9 from the operation unit 318 of the MFP 102. Then, if the user is permitted to access the BOX No. 2, the CPU 301 displays the screen 2001 in FIG. 20 on the display device 317.

Referring to FIG. 20, the screen 2001 includes a number 2002 of a user-accessible BOX area, numbers 2003 and 2004 of accessible documents stored in the BOX area, scroll buttons 2005 and 2006, the PREVIEW button 2007, the PRINT button 2008, and a CANCEL button 2009.

The user can print or preview data stored in a BOX area of the MFP 101, to which fingerprint authentication is required, through the operation unit 318 of the MFP 102 not including a fingerprint authentication device.

In the above-mentioned exemplary embodiment, the MFP 101 issues a permit by printing information such as biometric information on a sheet in step S1008. However, permit issuance is not limited thereto, but the MFP 101 may record biometric information on a storage medium such as an integrated circuit (IC) card in step S1008.

For example, the MFP 101 records information such as biometric information on a storage medium such as an IC card through the card authentication device 220. When the user accesses the MFP 101 from the MFP 102, in step S1604, the user instructs the card authentication device 320 of the MFP 102 to read information in the storage medium.

In step S1606, the MFP 102 transmits the read information to the MFP 101. Accordingly, the MFP 101 determines whether or not access from the MFP 102 is permitted based on the received information including biometric information.

In the above-mentioned exemplary embodiment, the MFP 101 includes a fingerprint information authentication device and uses fingerprint information as biometric information. However, biometric information is not limited thereto.

For example, it is possible to use face information, vein information, voiceprint information, palm shape information, retina information, iris information, or a combination of these pieces of information from the user as biometric information.

To acquire these pieces of information, it may be possible that the MFP 101 includes a biometric information input method corresponding to each piece of information while the MFP 102 does not includes thereof.

An example biometric information input method corresponding to each piece of information may be a camera that can image and detect a face in the case of face information or a microphone that can acquire voice in the case of voiceprint information. The MFP 101 may embed information including biometric information in the 2-dimensional bar code 1406 in FIG. 15 and then print it on a sheet.

Then, when the user accesses the MFP 101 from the MFP 102, the MFP 102 may perform control to scan the sheet and then transmit biometric information embedded in the 2-dimensional bar code 1406 to the MFP 101.

The present invention is applicable to a case where a user accesses an information processing apparatus including a specific device for authenticating information not limited to biometric information, from an information processing apparatus not including the specific authentication device. An example specific authentication device is, for example, a card reader, which reads a user ID and a password from an ID card.

In the above-mentioned exemplary embodiment, image processing apparatuses are used for an image processing system to which the present invention is applied. However, apparatuses are not limited to image processing apparatuses, but any information processing apparatuses may be used as long as they process information. Further, the image processing system may be an information processing system.

In the above-mentioned exemplary embodiment, information including biometric information is printed on a sheet. However, the information printed on a sheet may not include biometric information itself but may include information for acquiring biometric information.

In this case, biometric information is stored in a server connected to the network 104, and information including a Uniform Resource Identifiers (URI) indicating a location storing the biometric information is printed on a permit. Then, when the user accesses the MFP 101 from the MFP 102, the MFP 101 receives from the MFP 102 information such as a URI indicating a location storing biometric information in step S1607.

Then, the MFP 101 acquires biometric information from a storage location indicated by the URI and then determines whether or not access is permitted based on the acquired biometric information. Then, when the MFP 101 determines to permit access from the MFP 102, the MFP 101 permits access from the MFP 102.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-234442, filed Sep. 12, 2008, which is hereby incorporated by reference herein in its entirety.

What is claimed is:

1. An information processing apparatus capable of receiving access from an external apparatus, comprising:
a determination unit configured to determine whether access from the external apparatus is permitted based on biometric information;
a printing unit configured to print a permit;
a printing control unit configured to instruct the printing unit to print a permit including the biometric information;
a receiving unit configured to receive the biometric information included in the permit printed by the printing unit from the external apparatus; and
a control unit configured to permit access from the external apparatus if it is determined that access from the external apparatus is permitted based on biometric information received by the receiving unit in a case where an access request is received from the external apparatus.

2. The information processing apparatus according to claim 1, further comprising:
an authentication unit configured to authenticate a user by using authentication information other than the biometric information; and
a permission unit configured to permit printing of the permit including the information by using the printing control unit in a case where the user is authenticated by the authentication unit.

3. The information processing apparatus according to claim 1, further comprising a restriction unit configured to restrict issuance of the permit by the printing unit based on a number of issuances of the permit by the printing unit.

4. The information processing apparatus according to claim 1, wherein the control unit detects whether the external apparatus includes a biometric information input unit for inputting the biometric information, and, in a case where it includes the biometric information input unit, prohibits access based on the biometric information included in the permit.

5. The information processing apparatus according to claim 1, further comprising a generation unit configured to generate a temporary password in a case where the permit is printed by the printing unit,
wherein the control unit is configured to permit access from the external apparatus in a case where the receiving unit receives the biometric information and the temporary password generated by the generation unit and authentication of the user by the received biometric information and temporary password is successfully completed.

6. A method for controlling an information processing apparatus capable of receiving access from an external apparatuses, the method comprising:
determining whether access from the external apparatus is permitted based on biometric information;
instructing a printing unit to print a permit including the biometric information;
receiving the biometric information included in the printed permit from the external apparatus; and
permitting access from the external apparatus if it is determined that access from the external apparatus is permitted based on the received biometric information in a case where an access request is received from the external apparatus.

7. A storage medium for storing a program for instructing a computer to perform a method for controlling an information processing apparatus capable of receiving access from an external apparatus, the program comprising:
determining whether access from the external apparatus is permitted based on biometric information;
instructing a printing unit to print a permit including the biometric information;
receiving the biometric information included in the printed permit from the external apparatus; and
permitting access from the external apparatus if it is determined that access from the external apparatus is permitted based on the received biometric information in a case where an access request is received from the external apparatus.
